(19) United States
(12) Patent Application Publication
(10) Pub. No.: US 2013/0282859 A1
(43) Pub. Date: Oct. 24, 2013

(54) SYSTEM AND METHOD FOR ENABLING THE STYLING AND ADORNMENT OF MULTIPLE, DISPARATE WEB PAGES THROUGH REMOTE METHOD CALLS

(71) Applicant: Jason Shaun McDonald, Goose Creek, SC (US)

(72) Inventor: Jason Shaun McDonald, Goose Creek, SC (US)

(73) Assignee: BENEFITFOCUS.COM, INC., Charleston, SC (US)

(21) Appl. No.: 13/452,580

(22) Filed: Apr. 20, 2012

(51) Int. Cl. G06F 15/16

(52) U.S. Cl. 709/217

(57) ABSTRACT

A method and system for enabling the real-time styling and adornment of multiple disparate web pages through remote method calls. A local host may request content created from resources on a remote host. The remote host may accept parameters from the local host that allow for customization of the remote content that is returned. The customization may include attributes, a render type, and a style. The remote content may comprise data sets that could hold appropriate layout, branding, images, text, hyperlink paths, or the like. In some embodiments, the remote content is cached once it has been generated to allow it to be returned more quickly during future requests.

### TECHNICAL FIELD

This application relates to methods of displaying content having the same characteristics on disparate websites.

### BRIEF DESCRIPTION OF THE DRAWINGS

FIG. 1 is a block diagram of a system for returning customized remote content.

FIG. 2 is a flow chart of a method of returning customized remote content.

FIG. 3 is a web page containing multiple regions requiring resource requests to load content.

FIG. 4 is the web page from FIG. 3 after content is parsed from responses to resource requests.

FIG. 5 is a break out of an exemplary web page containing content from a remote host.

FIG. 6 is a break out of another exemplary web page containing alternate content from a remote host.

### DETAILED DESCRIPTION OF PREFERRED EMBODIMENTS

A local host may wish to display one or more web pages having the same characteristics, such as the same look, feel, and/or behavior, as remote web pages on one or more remote hosts. For example, multiple hosts may employ a single sign-on (“SSO”) scheme that allows a user to move from one host to another without reentering sign-on information. By making the web pages of each host have the same characteristics, the transition between hosts will feel even more seamless to users. The user may be able to jump between features or web pages of the different hosts without being confused by rearranged content or a sharp contrast in appearance or function. In some embodiments, the hosts have different characteristics and the characteristics of the first host will follow the user as she moves to web pages on other hosts. In other embodiments, a group of hosts will all have the same set of characteristics for users visiting any of the hosts.

One method of ensuring consistent characteristics is to manually maintain the content on each site such that it has the appropriate characteristics. Alternatively, hosts can be configured to automatically load the appropriate characteristics. In one embodiment, multiple hosts have access to the same resource set from which they load content with appropriate characteristics. In other embodiments, one or more hosts implement remote content methods that returns content with appropriate characteristics to hosts calling the remote content methods. Some embodiments may also implement a hybrid system where some hosts share resources and other hosts call remote methods to receive content.

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail in order to avoid obscuring more important aspects of the disclosure.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or detailed description is for illustrative purposes only and is not meant to imply a required order, unless specified to require an order.

Embodiments may include various steps, which may be embodied in machine-executable instructions to be executed by a computer system. A computer system comprises one or more general-purpose or special-purpose computers (or other electronic device). Alternatively, the computer system may comprise hardware components that include specific logic for performing the steps or comprise a combination of hardware, software, and/or firmware.

Embodiments may also be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/computer-readable medium suitable for storing electronic instructions.

Computer systems and the computers in a computer system may be connected via a network. Suitable networks for configuration and/or use as described herein include one or more local area networks, wide area networks, metropolitan area networks, and/or “Internet” or IP networks, such as the World Wide Web, a private Internet, a secure Internet, a value-added network, a virtual private network, an extranet, an intranet, or even standalone machines which communicate with other machines by physical transport of media (a so-called “sneakernet”). In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may comprise a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

The network may include communications or networking software, such as the software available from Novell, Microsoft, Artisoft, and other vendors, and may operate using TCP/IP, SPX, IPX, and other protocols over twisted pair, coaxial, or optical fiber cables, telephone lines, satellites, microwave relays, modulated AC power lines, physical media transfer, and/or other data transmission “wires” known to those of skill in the art. The network may encompass smaller networks and/or be connectable to other networks through a gateway or similar mechanism.

Each computer system includes at least a processor and a memory; computer systems may also include various input devices and/or output devices. The processor may include a general purpose device, such as an Intel®, AMD®, or other “off-the-shelf” microprocessor. The processor may include a special purpose processing device, such as an ASIC, SoC, SiP, FPGA, PAL, PLA, FPLA, PLD, or other customized or programmable device. The memory may include static RAM, dynamic RAM, flash memory, one or more flip-flops, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, random access memory, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer executable code located within a memory device. A software module may, for instance, comprise one or more physical or logical blocks of computer instructions, which may be organized as a routine, program, object, component, data structure, etc., that perform one or more tasks or implement particular abstract data types.

In certain embodiments, a particular software module may comprise disparate instructions stored in different locations of a memory device, different memory devices, or different computers, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the present invention is already available, such as: general purpose computers; computer programming tools and techniques; computer networks and networking technologies; digital storage media; authentication; access control; and other security tools and techniques provided by public keys, encryption, firewalls, and/or other means.

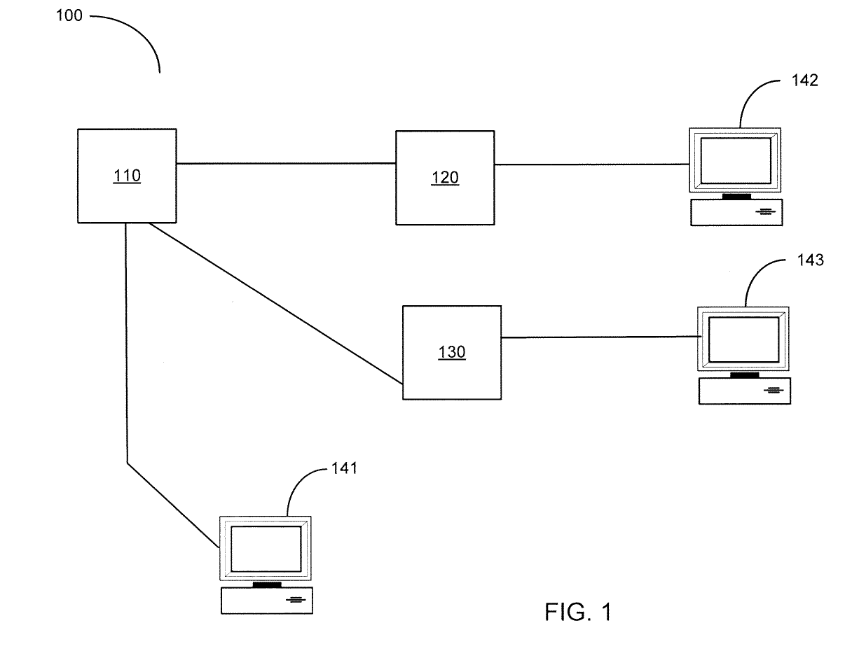

FIG. 1 is a block diagram of a system 100 on which the methods disclosed herein may be implemented. The system comprises a remote host 110 that may communicate over a network with a plurality of local hosts 120, 130. Various users 141, 142, 143 may also communicate with the hosts 110, 120, 130 over the network. For example, a user 142 may wish to view web pages located on one of the hosts 120. The web page on the local hosts 120 may contain content loaded from the remote host 110. To display this content, the local host 120 requests the content from the remote host 110 by calling a remote content method implemented by the remote host. In some embodiments, the local host 120 would like the content returned by the remote host 110 to be custom tailored, such as by containing custom text or titles. The local host 120 may pass attributes to the remote host 110 to receive remote content customized by the attributes.

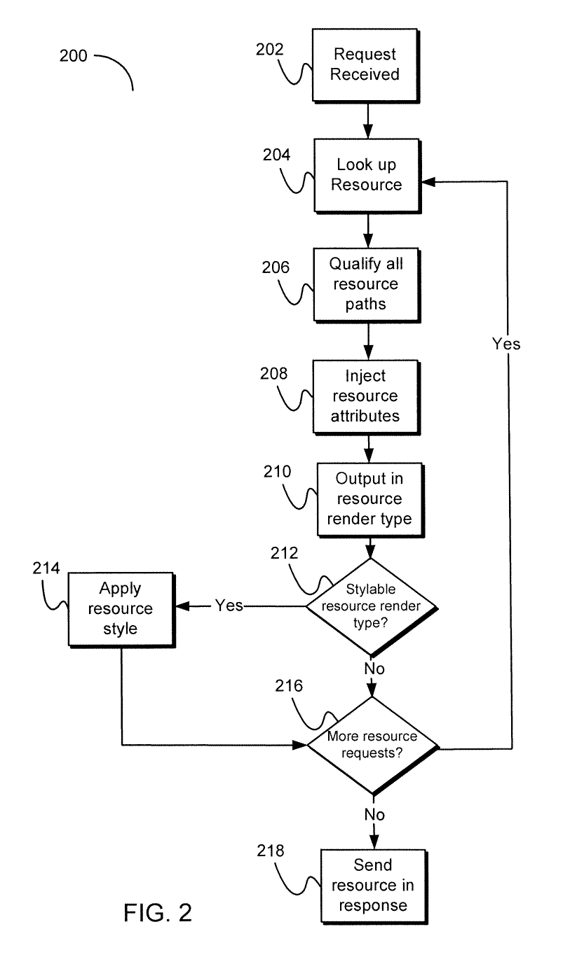

FIG. 2 is a flow chart of a method 200 performed by the remote host 110 to return customized remote content. The method 200 begins when the remote host 110 receives 202 a request for a resource that can be turned into content. The request may contain parameters, such as a resource identifier, a resource render type, a resource style, and one or more resource attributes. In some embodiments, the parameters may be encapsulated within an object, and the resource request may contain multiple objects indicating a plurality of resources to be returned. The local host 120 may make the request in some embodiments. Alternatively, the local host 120 may inform the user 142 to make the resource request. The user 142 request may be made synchronously with the loading of the web page, or the user 142 may be able to make the request asynchronously, such as by using asynchronous javascipt and XML (“AJAX”).

The remote host 110 then looks up 204 the resource using the resource identifier in the request. The resource identifier parameter indicates what resource the local host 120 is requesting. In some embodiments, the identifier may be a numeric or alpha numeric code referring to the desired resource. In other embodiments, the identifier may be a word or abbreviation that is understandable by a human designing a web page as well as the remote host 110. For example, the identifier may be “header,” “footer,” “menu”, or the like in some embodiments. The remote host 110 uses the resource identifier to locate the resource. The resource may be stored in a local memory, or it may need to be loaded from another host or computer system.

Once the resource is loaded, the remote host 110 qualifies 206 all resource paths. The resource may comprise hyperlinks, images, and other outside content. The resource may use relative paths in hyperlinks or when indicating the location on the remote host 110 from which to load the outside content. The local host 120 may incorrectly resolve a relative path as referring to non-existent locations on the local host 120 if they are not corrected. The remote host 110 qualifies the resource paths by converting the relative paths into absolute paths. This allows the local host 120 to resolve all paths correctly. In other embodiments, all resources on the remote host 110 may be designed in advance to use absolute paths.

Next, the remote host 110 injects resource attributes 208. The resource attributes allow the local host 120 to customize various aspects of the resource. For example, when requesting a header resource, the resource attributes may include a title, slogan, logo, or the like to be placed in the header. Thus, web pages across hosts may have the same characteristics while still identifying which host is providing the current web page. The type and number of resource attributes available to the local host 120 may vary in some embodiments depending on the particular resource requested. The remote host 110 modifies the resource in accordance with any attributes that have been specified by the local host 120. In some embodiments, unspecified attributes may be result in a default attribute being used or no attribute being applied.

The remote host 110 then converts 210 the resource into renderable content of the requested render type. The render type parameter indicates the format of the renderable content. This may include XML, HTML, JSON, or the like for web content. For image and document content, the render type may specify an image format or document type. In alternate embodiments, a resource may be stored in multiple render types, and renderable content of the appropriate render type is loaded as part of step 210. The renderable content may comprise data sets that hold appropriate layout, branding, images, text, hyperlink paths, or the like.

Once the resource has been converted, the remote host 110 determines 212 whether the render type is capable of being styled. For example, some images, web content, and documents, such as portable document format (“pdf”) documents, may not be capable of being styled. Additionally, the remote host 110 may determine at this point whether the resource style parameter has been specified in the remote content method call. In some embodiments, if no style is specified, the remote host 110 skips applying 214 the resource style. In other embodiments, the remote host 110 proceeds to step 214 even if no style is specified. Alternatively, the remote host 110 may determine whether to perform step 214 when no style is specified based on the resource identifier.

The remote host 110 then applies 214 the style in those cases when it is appropriate. The resource style parameter indicates the type of style that should be applied to the renderable content. The resource style may be specified using cascading style sheets (“CSS”) in some embodiments or other formats of specifying style. Alternatively, the resource style may be a reference to predefined styles stored on the remote host 110, which may be stored in CSS or other formats. In some embodiments, a null, empty, default value, or the like may indicate to the remote host 110 to apply its own style. The resource request may not include a resource style in other embodiments. The remote host 110 may apply its own style if none is specified.

Next, the remote host 110 determines 216 whether additional resources were requested. If another resource is needed, the remote host 110 returns to step 204 for the next resource. Otherwise, the remote host 110 proceeds with returning 218 the styled, renderable content in response to the request. In other embodiments, the steps 204 to 214 may be performed in parallel by performing each step for all resources before proceeding to the next or by creating a separate thread for each resource requested with the threads running in parallel.

When each resource that was requested has been processed, the remote host 110 returns 218 the styled, renderable content in a response sent to the local host. In some embodiments, the response may comprise the styled, renderable content broken up by each resource requested. In other embodiments, each resource is returned in a separate response as soon as processing of that resource is completed to speed loading of the web page. Once the local site 120 or user 142 receives the response, it parses the response and displays the styled, renderable content in the appropriate region.

In some embodiments, the remote 110 and/or local host 120 engages in caching. For content individualized for a single user, the local host 120 may cache the styled, renderable content for the duration of the user's session and may clear the cached content if a request has not been received from the user 142 within a predetermined time. For non-individualized content, the local host 120 may cache the content for a predetermined time, such as a day, a week, a month, or the like.

The remote host 110 may cache non-individualized content for predetermined time, or it may check a modified date of the resource to determine whether to use the cached content. In some embodiments, the remote host 110 may clear a portion of its cache and/or notify the local host 120 when a resource has been modified. Alternatively, the remote host 110 may delete content from the cache when the space is needed for new content. For individualized content, the remote host 110 may cache a partially processed resource without the individualizing attributes applied. The remote host 110 may also clear individualized content after a predetermined time or when space is needed. For cached content, the remote host 110 immediately returns the cached content when a request is received and it does not perform steps 204 to 214.

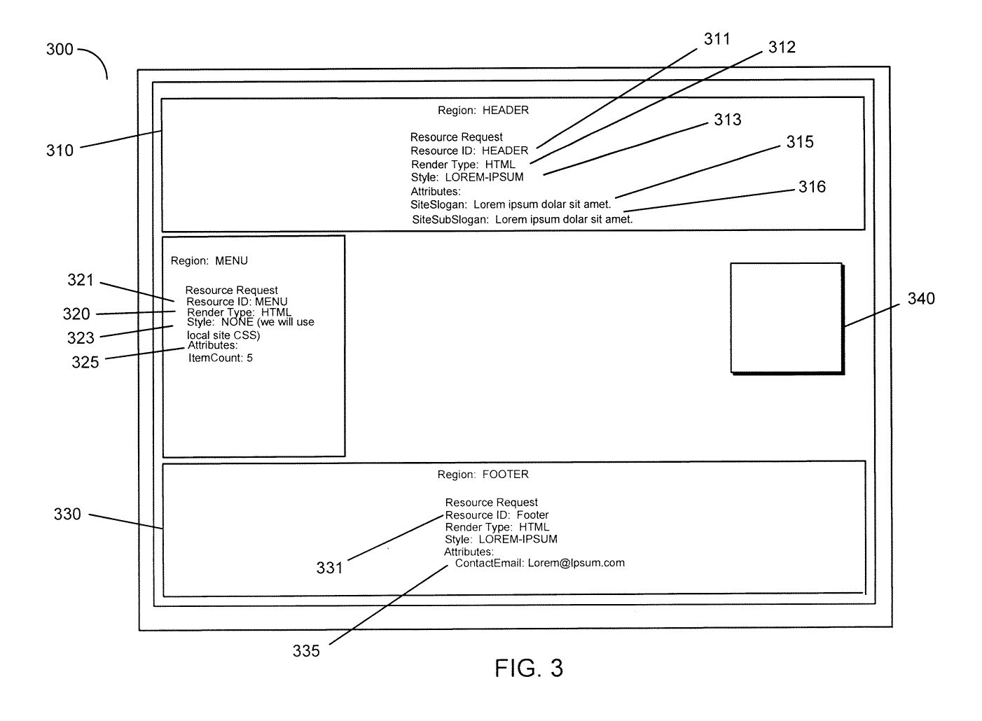

FIG. 3 is a web page 300 containing multiple regions 310, 320, 330 requiring resource requests to load content. The web page 300 also contains content from the local site 340. In FIG. 3, resource requests are depicted in the region where the returned content is to be loaded. One region 310 may require a header from the remote host 110. The local host 120 may submit a resource request with a resource ID 311 of “Header,” a render type 312 of “HTML,” and a resource style 313 of “Lorem-Ipsum.” The “Header” resource may comprise a “SiteSlogan” attribute 315 and a “SiteSubSlogan” attribute 316 that specify text to appear in the header. Another region 320 may require a menu, so the resource ID 321 is “Menu.” For this request, the local host 120 may wish to specify its own style, so it sets the resource style 323 to “None.” The “Menu” may accept an “ItemCount” attribute 325 that specifies the number of items in the menu. Finally, for a footer region, the local host 120 may submit a request with a resource ID 331 of “Footer,” that takes “ContactEmail” 335 as an attribute.

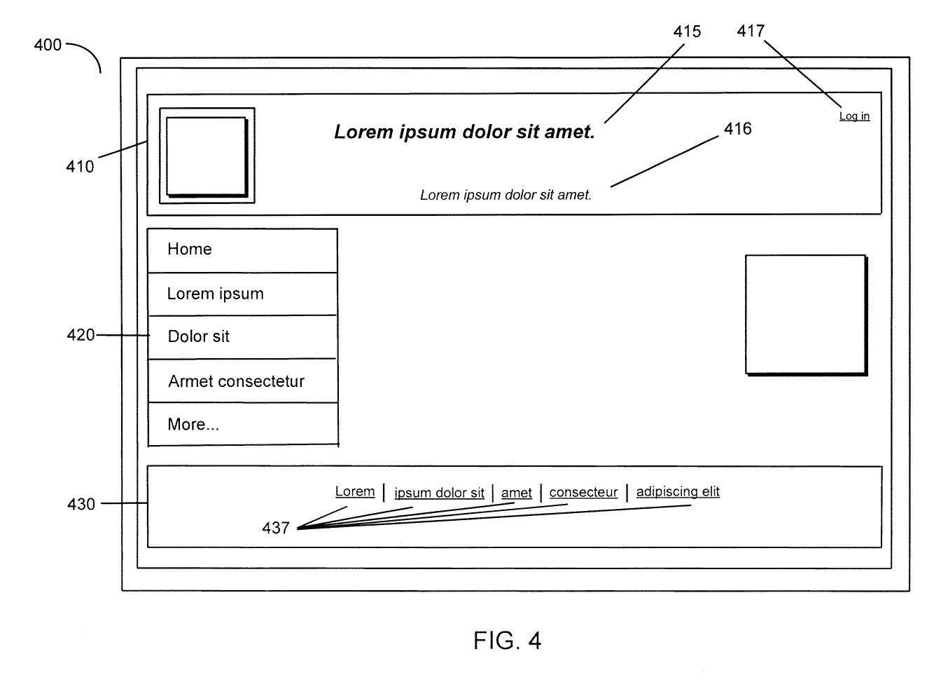

FIG. 4 is a web page 400 that results once the local host 120 has received and parsed responses to its resource requests. A header 410 contains the text 415, 416 from the “SiteSlogan” attribute 315 and “SiteSubSlogan” attribute 316 passed to the remote host 110. Additionally, the remote host 110 has applied its own attributes to the header 410, such as by inserting a “Log in” link 417 in the upper right hand corner. Similarly, the footer 430 has a set of links 437 inserted by the remote host 110. The local host 120 has applied its own style to the menu 420. This may allow a user to distinguish between features, such as the menu 420, that will allow for navigation of the web pages on the local host 120 and features, such as the footer links 437, that will allow for navigation of web pages on the remote host 110 or among several hosts. The local host 120 may have overwritten the style applied by the remote host 110, or no style may have been applied.

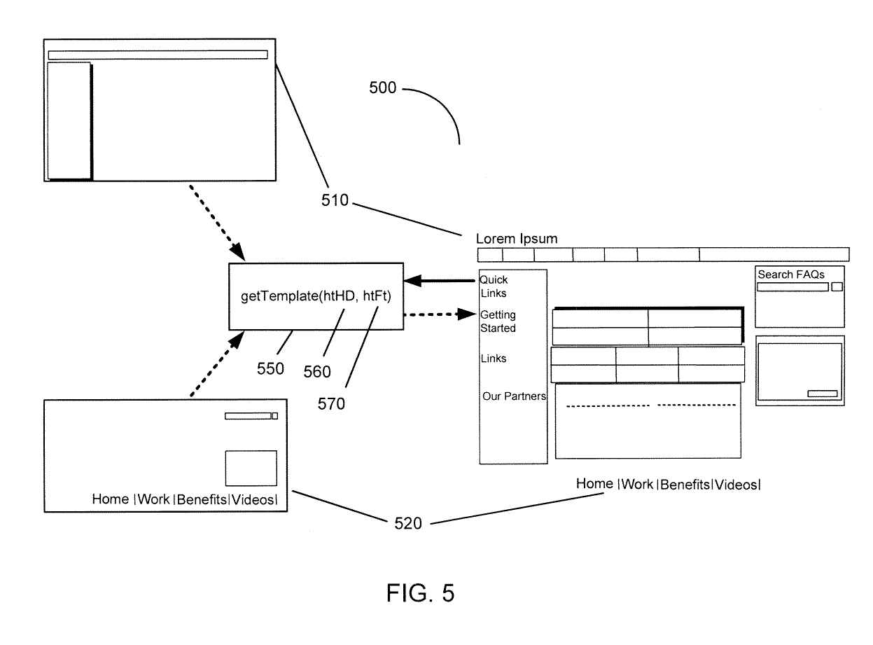

FIG. 5 is a break out of an exemplary web page 500 containing content 510, 520 from a remote host 110. The remote content 510, 520 includes a header 510 and a footer 520 for display by the local host 120. The local host 120 calls the remote content method 550 with an object 560 for a header request and an object 570 for a footer request. The remote content method 550 generates the header 510 and footer 520 from the objects passed to it. It then returns the header 510 and footer 520 to the local host 120, which wraps its content 540 with the header 510 and footer 520. The returned web page 500 incorporating the remote header and footer may be more visually pleasing and user friendly than other methods of loading remote headers and footers, such as using iFrames.

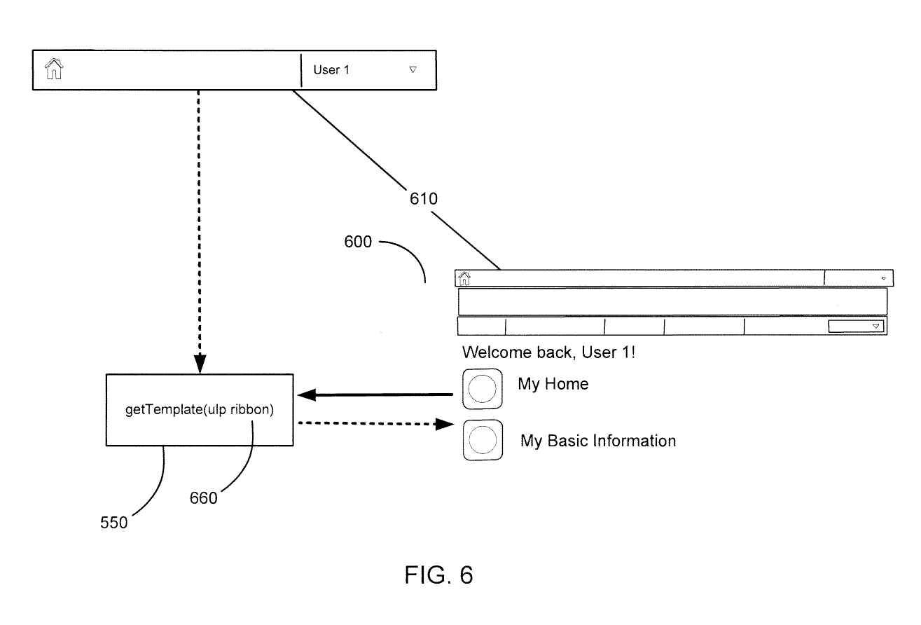

FIG. 6 is a break out of an exemplary web page 600 containing alternate content 610 from a remote host 110. In this example, the local host 120 loads a navigation ribbon 610 from the remote host. The local host 120 again calls the remote content method 550, but this time passes an object 660 for a ribbon request. The navigation ribbon 610 may allow a user to navigate among multiple sites, such as under an SSO scheme. Each site uses the navigation ribbon 610 to provide navigation to other cooperating sites. The user is able to more easily interact with the websites and move among them because the navigation ribbon is consistent among the cooperating sites. This allows the user to avoid searching around on each site to find the location of links to other cooperating sites.

It will be obvious to those having skill in the art that many changes may be made to the details of the above-described embodiments without departing from the underlying principles of the disclosure. The scope of the present disclosure should, therefore, be determined only by the following claims.

1. A method of returning customized remote content from a computer system, the method comprising:
receiving a request for remote content at a computer system, the request comprising:
a resource identifier; and
a render type;
loading a resource corresponding to the resource identifier to the computer system;
converting the resource to renderable content of the render type; and
returning the renderable content.

2. The method of claim 1, further comprising injecting one or more resource attributes, wherein the request for remote content further comprises the one or more resource attributes.

3. The method of claim 1, further comprising applying a resource style to the renderable content, wherein the request for remote content further comprises the resource style.

4. The method of claim 1, further comprising:
determining whether the render type is capable of being styled; and
applying a resource style to the renderable content if the resource is capable of being styled,
wherein the request for remote content further comprises the resource style.

5. The method of claim 4, wherein the resource style is a default value and applying the resource style comprises applying a default resource style.

6. The method of claim 1, further comprising qualifying resource paths in the resource before converting the resource to the renderable content.

7. The method of claim 1, further comprising storing the renderable content in a cache.

8. The method of claim 7, further comprising:
receiving a second request for remote content, the request comprising:
the resource identifier; and
the render type;
loading the renderable content from the cache; and
returning the renderable content.

9. A non-transitory computer readable storage medium having stored thereon computer-readable instruction code for a computer system to perform a method of returning customized remote content, the method comprising:
receiving a request for remote content, the request comprising:
a resource identifier; and
a render type;
loading a resource corresponding to the resource identifier;
converting the resource to renderable content of the render type; and
returning the renderable content.

10. The non-transitory computer readable storage medium of claim 9, wherein the method further comprises injecting one or more resource attributes, and wherein the request for remote content further comprises the one or more resource attributes.

11. The non-transitory computer readable storage medium of claim 9, wherein the method further comprises applying a resource style to the renderable content, and wherein the request for remote content further comprises the resource style.

12. The non-transitory computer readable storage medium of claim 9, wherein the method further comprises:
determining whether the render type is capable of being styled; and
applying a resource style to the renderable content if the resource is capable of being styled, and
wherein the request for remote content further comprises the resource style.

13. The non-transitory computer readable storage medium of claim 12, wherein the resource style is a default value and applying the resource style comprises applying a default resource style.

14. The non-transitory computer readable storage medium of claim 9, wherein the method further comprises qualifying resource paths in the resource before converting the resource to the renderable content.

15. The non-transitory computer readable storage medium of claim 9, wherein the method further comprises storing the renderable content in a cache.

16. The non-transitory computer readable storage medium of claim 15, wherein the method further comprises:
receiving a second request for remote content, the request comprising:
the resource identifier; and
the render type;
loading the renderable content from the cache; and
returning the renderable content.

17. A computer system to return customized remote content, the computer system comprising:
a processor; and
a memory in electrical communication with the processor, the memory comprising:
an operating system; and
a customized remote content module to perform the method comprising:
receiving a request for remote content, the request comprising:
a resource identifier; and
a render type;
loading a resource corresponding to the resource identifier;
converting the resource to renderable content of the render type; and
returning the renderable content.

18. The computer system of claim 17, wherein the method performed by the customized remote content module further comprises injecting one or more resource attributes, wherein the request for remote content further comprises the one or more resource attributes.

19. The computer system of claim 17, wherein the method performed by the customized remote content module further comprises applying a resource style to the renderable content, wherein the request for remote content further comprises the resource style.

20. The computer system of claim 17, wherein the method performed by the customized remote content module further comprises:
determining whether the render type is capable of being styled; and
applying a resource style to the renderable content if the resource is capable of being styled, and
wherein the request for remote content further comprises the resource style.

21. The computer system of claim 20, wherein the resource style is a default value and applying the resource style comprises applying a default resource style.

22. The computer system of claim 17, wherein the method performed by the customized remote content module further comprises qualifying resource paths in the resource before converting the resource to the renderable content.

23. The computer system of claim 17, wherein the method performed by the customized remote content module further comprises storing the renderable content in a cache.

24. The computer system of claim 23, wherein the method performed by the customized remote content module further comprises:
receiving a second request for remote content, the request comprising:
the resource identifier; and
the render type;
loading the renderable content from the cache; and
returning the renderable content.
